(19) United States
(12) Patent Application Publication
(10) Pub. No.: US 2016/0086350 A1
(43) Pub. Date: Mar. 24, 2016

(54) APPARATUSES, METHODS AND SYSTEMS FOR RECOVERING A 3-DIMENSIONAL SKELETAL MODEL OF THE HUMAN BODY

(71) Applicant: Foundation for Research and Technology - Hellas (FORTH) acting through its Institute of Computer, Heraklion (GR)

(72) Inventors: Damien Michel, Heraklion (GR); Antonis Argyros, Heraklion (GR)

(73) Assignee: Foundation for Research and Technology - Hellas (FORTH) (acting through its Institute of Computer, Heraklion (GR)

(21) Appl. No.: 14/860,780

(22) Filed: Sep. 22, 2015

Related U.S. Application Data
(60) Provisional application No. 62/053,667, filed on Sep. 22, 2014.

(51) Int. Cl. G06T 7/20; G06T 7/00

(52) U.S. Cl. CPC G06T 7/2046; G06T 7/0046; G06T 7/2086; G06T 2207/10024; G06T 2207/10021; G06T 2207/10028; G06T 2200/04

(57) ABSTRACT

The ARS offers tracking, estimation of position, orientation and full articulation of the human body from marker-less visual observations obtained by a camera, for example an RGBD camera. An ARS may provide hypotheses of the 3D configuration of body parts or the entire body from a single depth frame. The ARS may also propagates estimations of the 3D configuration of body parts and the body by mapping or comparing data from the previous frame and the current frame. The ARS may further compare the estimations and the hypotheses to provide a solution for the current frame. An ARS may select, merge, refine, and/or otherwise combine data from the estimations and the hypotheses to provide a final estimation corresponding to the 3D skeletal data and may apply the final estimation data to capture parameters associated with a moving or still body.

### CROSS-REFERENCE TO RELATED APPLICATION

This application claims the benefit of U.S. Provisional Application No. 62/053,667, filed Sep. 22, 2014, which is incorporated by reference in its entirety as if fully set forth herein.

### TECHNICAL FIELD

The present subject matter is directed generally to apparatuses, methods, and systems of detection, tracking, and/or recognition of a human body, and particularly, to APPARATUSES, METHODS AND SYSTEMS FOR RECOVERING A 3-DIMENSIONAL SKELETAL MODEL OF THE HUMAN BODY (“ARS”).

### RELATED ART

Because of its high theoretical and practical interest, human motion capture based on vision has been the theme of numerous research efforts. (see, e.g., Moeslund, T. B., Hilton, A., Kru, V., 2006. A Survey of Advances in Vision-based Human Motion Capture and Analysis. CVIU 104, 90-126; Poppe, R., 2007. Vision-based human motion analysis: An overview. CVIU 108 (1-2), special Issue on Vision for Human-Computer Interaction.). More recently, Chen et al. (Chen, L., Wei, H., Ferryman, J., 2013. A survey of human motion analysis using depth imagery. Pattern Recognition Letters 34 (15), 1995.) surveyed methods for human motion estimation based on depth cameras. Most commercial solutions to the problem of human motion capture make use of special markers that are placed on carefully selected (e.g., joints) points of the subject's body. (e.g., Vicon, 2013. Vicon: Motion capture systems. URL http://www.vicon.com) The present subject matter discloses an exemplary method for markerless motion capture technique as an unobtrusive solution to marker-based solutions.

Markerless human motion capture techniques may be classified into two broad classes: bottom-up and top-down. Bottom up methods extract a set of features from the input images, and try to map them to the human pose space. (see, e.g., Bisacco, A., Ming-Hsuan, Y., Soatto, S., 2007. Fast human pose estimation using appearance and motion via multi-dimensional boosting regression. In: IEEE CVPR.; Pons-Moll, G., Leal-Taixe, L., Truong, T., Rosenhahn, B., 2011. Efficient and robust shape matching for model based human motion capture. In: Mester, R., Felsberg, M. (Eds.), Pattern Recognition. Vol. 6835 of Lecture Notes in Computer Science. Springer Berlin Heidelberg, pp. 416-425; Shotton, J., Fitzgibbon, A., Cook, M., Sharp, T., Finocchio, M., Moore, R., Kipman, A., Blake, A., 2011. Real-Time Human Pose Recognition in Parts from Single Depth Images; Sigal, L., Isard, M., Haussecker, H., Black, M., 2012. Loose-limbed people: Estimating 3d human pose and motion using non-parametric belief propagation. IJCV 98 (1), 15-48; Sminchisescu, C., Kanaujia, A., Li, Z., Metaxas, D., 2005. Discriminative density propagation for 3d human motion estimation. In: IEEE CVPR. Vol. 1. pp. 390-397 vol. 1.) This is achieved with a learning process that involves a typically large database of known poses that cover as much as possible the whole human poses search space. The type of descriptors employed, the mapping method and the actual poses database are the factors determining the accuracy and efficiency of these methods. Due to their nature, most of their computing time is spend on the offline processes of database creation and mapping.

Top-down approaches use an articulated model of the human body and try to estimate the joints angles that would make the appearance of this model fit best the visual input. (see, e.g., Corazza, S., Mundermann, L., Gambaretto, E., Ferrigno, G., Andriac chi, T., 2010. Markerless motion capture through visual hull, articulated icp and subject specific model generation. IJCV 8₇ (1-2), 156-169; Deutscher, J., Reid, I., 2005. Articulated body motion capture by stochastic search. IJCV 61 (2), 185-205; Gall, J., Rosenhahn, B., Brox, T., Seidel, H.-P., 2010. Optimization and filtering for human motion capture. IJCV 8₇ (1-2), 75-92; Gall, J., Stoll, C., de Aguiar, E., Theobalt, C., Rosenhahn, B., Seidel, H. P., 2009. Motion capture using joint skeleton tracking and surface estimation. In: IEEE CVPR. pp. 1746-1753; Vijay, J., Trucco, E., Ivekovic, S., 2010. Markerless human articulated tracking using hierarchical particle swarm optimisation. Image and Vision Computing 28 (11), 1530-1547; Zhang, L., Sturm, J., Cremers, D., Lee, D., October 2012. Real-time human motion tracking using multiple depth cameras. In: Proc. of the International Conference on Intelligent Robot Systems (IROS).) The model is usually made of a base skeleton and an attached surface. In some methods, complex surface deformations are allowed. (e.g., Gall, J., Stoll, C., de Aguiar, E., Theobalt, C., Rosenhahn, B., Seidel, H. P., 2009. Motion capture using joint skeleton tracking and surface estimation. In: IEEE CVPR. pp. 1746-1753.) Having defined a model of the human body, different pose hypotheses can be formed. A typical top-down method consists of generating hypotheses and comparing them to the input visual data. The comparison is performed based on an objective function that measures the discrepancy between a pose hypothesis and the actual observations. The minimization of this objective function determines the pose that best explains the available observations. Typically, this is formulated as an optimization problem that amounts to the exploration of a very high dimensional search space. Kinematic constrains based on physiological data are often applied to the model, excluding unrealistic poses and reducing significantly that search space. Constraining not only the pose but also the motion itself can further help reducing the complexity, for example with Kalman fillers. (e.g., Mikic, I., Trivedi, M., Hunter, E., Cosman, P., 2003. Human body model acquisition and tracking using voxel data. IJCV 53 (3), 199-223.) However, this means a reduced generality and the necessity to build and learn human motion models. The employed model can be changed easily, and the whole search space can be explored without any form of training. Top-down approaches are associated with high computational cost of the online process. Due to their generative nature, most of the computational work needs to be performed online. Two more shortcomings is the requirement for knowing the body model parameters of each individual and the requirement of providing an initial pose to be tracked.

### SUMMARY

A processor-implemented method for markerless estimation of a 3D skeletal model of a human body may comprise (a) receiving a current RGBD frame depicting at least a portion of a human body; (b) receiving an estimation of the position of the depicted at least one portion of the human body that was estimated based on a previous RGBD frame; (c) determining at least one hypothesis of a position of the depicted at least one portion of the human body from the current RGBD frame; (d) comparing the current RGBD frame to the estimation of the position of the depicted at least one portion of the human body that was estimated based on a previous RGBD frame; and (e) estimating a current position of the depicted at least one portion of the human body based on the at least one hypothesis from (c) and a result of the comparison in (d).

In another aspect, at least two hypotheses of the position of the depicted at least one portion of the human body are determined from the current RGBD frame at (c); and step (e) includes determining whether to accept one of the at least two hypotheses, refine one of the at least two hypotheses, merge two or more of the at least two hypotheses or reject all hypotheses.

In another aspect, step (d) results in at least one hypothesis of a position of the depicted at least one portion of the human body; and step (e) includes determining whether to accept one hypothesis from (c) or (d), refine one hypothesis from (c) or (d), merge two or more of the hypotheses from (c) and (d), or reject all hypotheses.

In another embodiment, a processor-implemented method for markerless estimation of a 3D skeletal model of a human body, comprises (a) receiving a current RGBD frame depicting at least a body and arms of a human body; (b) receiving an estimation of the positions of the body and arms of the human body that were estimated based on a previous RGBD frame; (c) determining at least one body hypothesis of a position of the body of the human body from the current RGBD frame; (d) determining at least one arms hypothesis of a position of the arms of the human body from the current RGBD frame; (e) comparing the current RGBD frame to the estimation of the position of the body of the human body that was estimated based on a previous RGBD frame to provide a body comparison; (f) comparing the current RGBD frame to the estimation of the position of the arms of the human body that was estimated based on a previous RGBD frame to provide an arms comparison; (g) estimating a current position of the body of the human body based on the at least one body hypothesis from (c) and the body comparison in (e); and (h) estimating a current position of the arms of the human body based on the at least one arm hypothesis from (d) and the arm comparison in (f).

In another aspect, estimating a current position of the arms of the human body at (h) is also based on the estimation of the current position of the body of the human body from (g).

In another aspect, at least two body hypotheses of the position of the body of the human body are determined from the current RGBD frame at (c); and step (g) includes determining whether to accept one of the at least two body hypotheses, refine one of the at least two body hypotheses, merge two or more of the at least two body hypotheses, or reject all body hypotheses.

In another aspect, at least two arm hypotheses of the position of the arm of the human body are determined from the current RGBD frame at (d); and step (h) includes determining whether to accept one of the at least two arm hypotheses, refine one of the at least two body hypotheses, merge two or more of the at least two arm hypotheses, or reject all arm hypotheses.

In another aspect, step (e) results in at least one hypothesis of a position of the body of the human body; and step (g) includes determining whether to accept one hypothesis from (c) or (e), refine one hypothesis from (c) or (e), merge two or more of the hypotheses from (c) and (e), or reject all hypotheses.

In another aspect, step (f) results in at least one hypothesis of a position of the body of the human body; and step (h) includes determining whether to accept one hypothesis from (d) or (f), refine one hypothesis from (d) or (f), merge two or more of the hypotheses from (d) and (f), or reject all hypotheses.

In another embodiment, a computing device comprises a processor; a display; a memory communicatively coupled to the processor, the memory comprising (a) a RGBD frame receiving module that receives a current RGBD frame depicting at least a portion of a human body; (b) a historical estimation receiving module that receives an estimation of the position of the depicted at least one portion of the human body that was estimated based on a previous RGBD frame; (c) a position determination module that determines at least one hypothesis of a position of the depicted at least one portion of the human body from the current RGBD frame; (d) a comparison module that compares the current RGBD frame to the estimation of the position of the depicted at least one portion of the human body that was estimated based on a previous RGBD frame; and (e) an estimation module that estimates a current position of the depicted at least one portion of the human body based on the at least one hypothesis from (c) and a result of the comparison by (d).

In another aspect, at least two hypotheses of the position of the depicted at least one portion of the human body are determined from the current RGBD frame by the position determination module (c); and the estimation module (e) determines whether to accept one of the at least two hypotheses, refine one of the at least two hypotheses, merge two or more of the at least two hypotheses, or reject all hypotheses.

In another aspect, the comparison module (d) outputs at least one hypothesis of a position of the depicted at least one portion of the human body; and the estimation module (e) determines whether to accept one hypothesis from the determination module (c) or the comparison module (d), refine one hypothesis from determination module (c) or the comparison module (d), merge two or more of the hypotheses from determination module (c) and the comparison module (d), or reject all hypotheses.

### BRIEF DESCRIPTION OF THE DRAWINGS

The accompanying appendices and/or drawings illustrate various non-limiting, example, inventive aspects in accordance with the present disclosure:

FIG. 1 is an exemplary illustration of the upper human body model, according to an implementation of the present subject matter;

FIG. 2 is a flow diagram showing an exemplary method for estimating 3D position, orientation and articulation of the human body, according to an implementation of the present subject matter;

FIG. 3 is a block diagram illustrating embodiments of an exemplary ARS controller, according to an implementation of the present subject matter;

FIGS. 4-36 depict a series of screenshots of an exemplary computer-implemented ARS, according to an implementation of the present subject matter;

FIG. 37 is a flow diagram of an exemplary ARS system;

FIG. 38 is a flow diagram of a body detection and tracking module of an exemplary ARS system;

FIG. 39 is a flow diagram of a limbs detection and tracking module of an exemplary ARS system; and

FIG. 40 is a flow diagram of a hands detection and tracking module of an exemplary ARS system.

It should be appreciated by those skilled in the art that any block diagrams herein represent conceptual views of illustrative systems. Similarly, it should be appreciated that any flow charts, flow diagrams, state transition diagrams, pseudo code, and the like represent various processes, which may be substantially represented in a computer readable medium and so executed by a computer or processor, whether or not such computer or processor is explicitly shown.

### DETAILED DESCRIPTION

Embodiments of the APPARATUSES, METHODS AND SYSTEMS FOR RECOVERING A 3-DIMENSIONAL SKELETAL MODEL OF THE HUMAN BODY (“ARS”) offer estimation of position, orientation and articulation of the human body from markerless visual observations obtained by a camera, for example an RGBD camera, that is a camera that allows for RGB color space with a depth component. In other implementations, the ARS can be applied to or configured for any application involving tracking, orientation or articulation of a moving or still human body. According to an implementation, the exemplary methods and systems generate estimation data related to the articulated motion of the human body. The ARS may take into consideration high dimensionality and the variability of the tracked person regarding appearance, body dimensions, etc. As discussed above, traditional approaches use expensive, special hardware and/or are invasive, e.g., require that special visual or other markers are carefully placed on the human body to be tracked. To that end, unobtrusive, markerless tracking disclosed herein does not interfere with the environment, the subject and/or its actions. Furthermore, some embodiments of the exemplary methods offer various advantages over traditional approaches, e.g., the methods described herein perform accurate markerless tracking of the human body in 3D, provide real time performance on a conventional computer, implement inexpensive sensory apparatus (RGBD or depth camera), exhibit robustness in a number of challenging conditions (illumination changes, environment clutter, camera motion, etc.), perform automatic human detection and automatic tracking initialization, and offer a high tolerance with respect to variations in human body dimensions, clothing, etc.

The methods disclosed herein combine the advantages of the top-down and bottom up approaches, along with other inventive features. In one embodiment, the exemplary methods do not depend on an offline learning process and do not suffer from the shortcomings of the appearance-based methods. At the same time, the employed 3D model of the human body is fit onto the observations provided by the RGBD camera with a very efficient method that removes the typically very high computational requirements of top-down methods. Additionally, In one embodiment, the exemplary method adapts automatically to different human subjects by adjusting properly the body model parameters to each individual and performs automatic human detection and 3D pose initialization.

In one implementation, the ARS provides hypotheses of the 3D configuration of body parts or the entire body from a single depth frame. The ARS also propagates estimations of the 3D configuration of body parts and the body by mapping or comparing data from the previous frame and the current frame. The ARS further compares the estimations and the hypotheses to provide a solution for the current frame. For example, in one implementation, ARS selects, merges, refines, and/or otherwise combines data from the estimations and the hypotheses to provide a final estimation corresponding to the 3D skeletal data. In one implementation, the exemplary methods and systems apply the final estimation data to capture parameters associated with a moving or still body.

The description and figures merely illustrate exemplary embodiments of the ARS. For example, the principles of ARS could be implemented with a variety of sensors, camera arrangements, and planar or 3-D movements. In another example, the implementations can be applied to the lower body as well as the upper body. It will thus be appreciated that, based on this disclosure, those skilled in the art will be able to devise various arrangements that, although not explicitly described or shown herein, embody the principles of the present subject matter. The ARS should not be construed as limited to one field, instead it will be understood that it can be extended to cover several applications, such as those where motion sensing technology is used, e.g., surveillance, game design, robotics and human-computer interaction, physical therapy, etc. Furthermore, all examples recited herein are intended to be for pedagogical purposes only to aid the reader in understanding the principles of the present subject matter and the concepts contributed by the inventors to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof. It will also be appreciated by those skilled in the art that the words, such as during, while, and when, as used herein, are not exact terms that mean an action takes place instantly upon an initiating action but that there may be some small but reasonable delay, such as a propagation delay, between the initial action and the reaction that is initiated by the initial action. Additionally, the word “connected” is used throughout for clarity of the description and can include either a direct connection or an indirect connection.

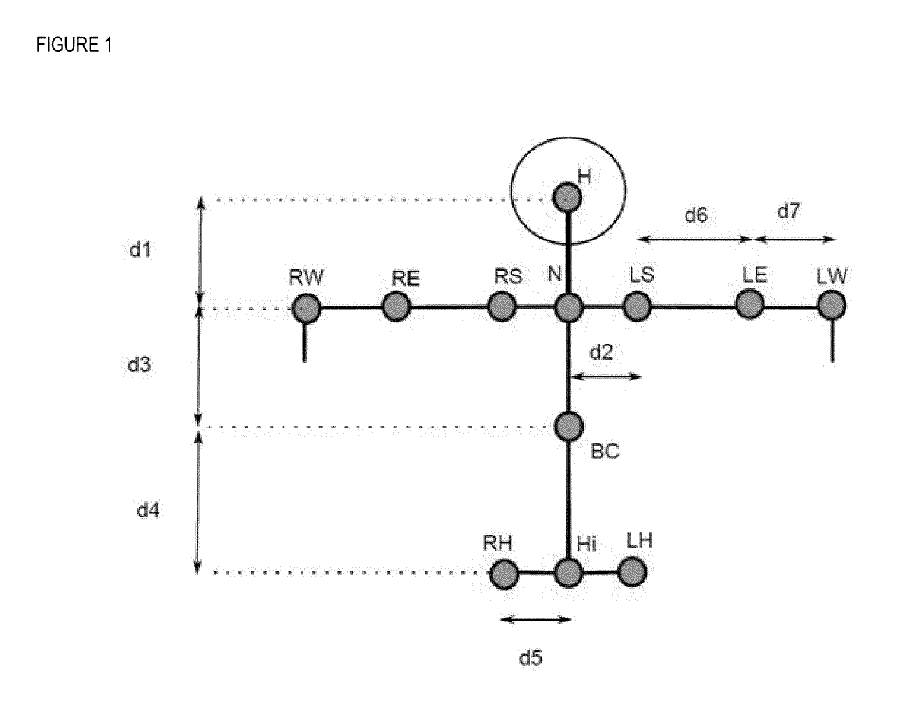

FIG. 1 is an exemplary illustration of the upper human body model, according to an implementation of the present subject matter. As shown in the figure, the 3D model encapsulates information about the 3D positions of the human head (H), neck (N), shoulders (RS and LS), elbows (RE and LE), wrists (RW and LW) and hips (RH, LH and Hi), as well as information about the body center (BC). For the purposes of the analysis, the upper body 3D model is hierarchically decomposed to (a) the main body part having the head, shoulders, body center and hips and (b) the arms. In one implementation, the employed 3d model can be extended to represent detailed information about the legs (not shown in FIG. 1, but which would extend from hips RH and LH). For example, the estimation of the position of the hips (RH, LH and Hi) in the model illustrated in FIG. 1 can be used to facilitate this extension.

In one implementation, a set of seven parameters (d1-d7) controls the size of each of the body parts, or a combination thereof. For example, (1) d1: head-neck (2) d2: neck-shoulder, (3) d3: neck-body center, (4) d4: body center-hip, (5) d5: hip-leg root, (6) d6: shoulder-elbow and (7) d7: elbow-wrist. In one implementation, the left/right symmetry of the human body is taken into account. The head may be modeled as a spherical object centered in the head position (H). Arms may be represented by two axis revolution volumes centered onto the shoulder-elbow and elbow-wrist 3D lines. The same applies to the body (neck, body center, hip points). All model parameters related to sizes (lengths and radiuses of primitives) may assume values in predefined, broad ranges that cover most of the variability of human bodies, and may be computed online. Several relations among these parameters from an external or internal anthropometric knowledge base (not shown) may be used and taken into account in the estimation process. Thus, the evaluation of one parameter may provide constraints on or suggestions as to others.

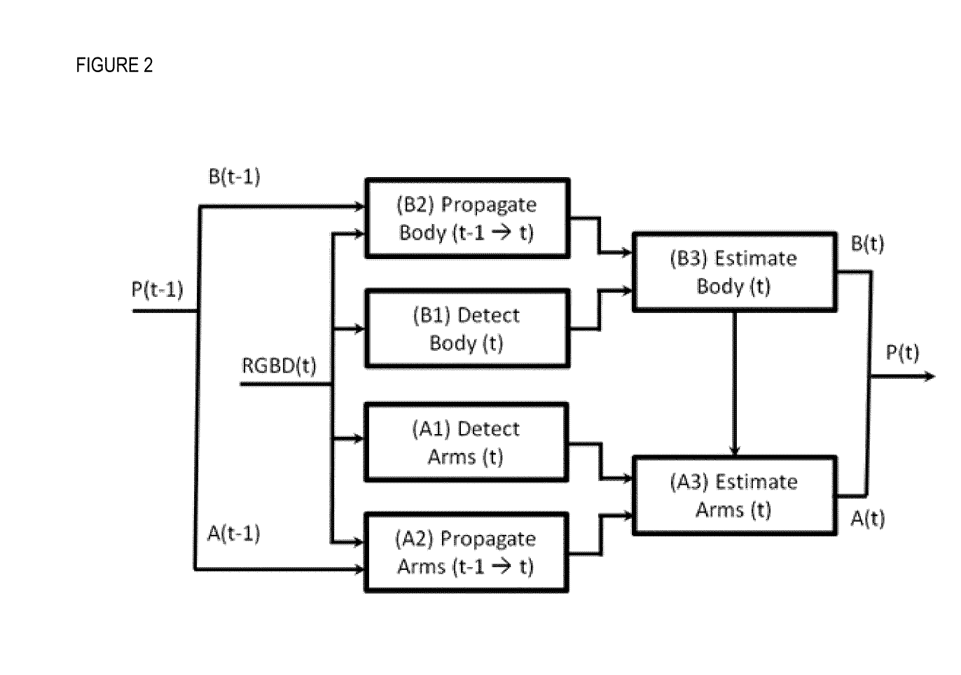

FIG. 2 is an exemplary method for estimating 3D position, orientation and articulation of the human body, according to an implementation of the present subject matter.

For example, in one implementation, a user may stand in front of a display with a standard or predetermined pose, such as a T-pose. The ARS may then automatically establish the relevant 3D-2D correspondences for a key frame. In other implementations, the ARS provides estimations for each frame, regardless of the body configuration. Furthermore, in one implementation, the estimations for a present frame may be combined or merged or otherwise compared with the propagated/tracked solutions of previous frames, if any. In addition, various sizes or measurements of a user's body (e.g., the user's height, shoulder width, waist height and arm lengths) and/or the face skin color may be extracted using a camera, such as the RGB-D camera. In other implementations, the user may not be using the upper body or may be using the upper and lower body. In these instances, the ARS also tracks the user's lower body. The ARS may also be configured to track a user's lower body instead of the user's lower body. Similarly, the ARS may be preconfigured to track any portion of a user's body irrespective of any sensed motion or movement of any particular portion of the user's body.

Further, in one implementation, at a time t, a previous human body estimation P(t−1) may be available as a result of the operation of the ARS on the input of the previous frame (time t−1). This is decomposed into two parts, the main human body part B(t−1) and the arms part A(t−1). It should be noted that B(t−1) may not be available, for example, because of being rejected due to low confidence. If B(t−1) exists, A(t−1) may be available fully (two arms) partially (one arm) or totally missing (no arms) again depending on the confidence associated with the detection of parts. At time t, the current RGBD frame RGBD(t) feeds the module (B1) of FIG. 2, which may perform a single-shot detection of human bodies and an estimation of their configuration, based on evidence that exists in this frame. This might result in several main body hypotheses. RGBD(t) together with B(t−1) feed the module (B2) that propagates (tracks) the main body estimation of the previous frame t−1 to the current one. The results of (B1) and (B2) provide a number of different hypotheses about the main body pose at time t. These hypotheses feed module (B3), which selects which hypothesis (or a combination of hypotheses) should be maintained, possibly after hypothesis merging and/or refinement.

A similar path in the flow diagram may be employed to handle the arms part of the human model. At time t, the current RGBD frame RGBD(t) feeds the module (A1) of FIG. 2, which performs a single-shot estimation of the two arms, i.e., based on evidence that exists only in the current frame. RGBD(t) together with A(t−1) may feed the module (A2) for propagating (tracking) the arms estimation of the previous frame t−1 to the current one. The results of A1 and A2 may provide several hypotheses about the arm(s) configuration at time t. The hypotheses feed module (A3) is configured for first refining the hypotheses and subsequently deciding whether these hypotheses are to be maintained, merged, or rejected. In one implementation, (A3) depends on the output of (B3) too, as the current body configuration B(t) is taken into account when the pose of the arms A(t) is decided. The resulting main body configuration B(t) (result of (B3)) and A(t) (result of (A3)) constitute the 3D pose estimation of the human upper body P(t) at time t. In one implementation, P(t) may be (a) empty (no solution found) (b) consisting of a human main body estimation only (in case of failure to form arm hypotheses with enough confidence) and (c) consisting of a human main body estimation and an estimation of one or both arms.

In one implementation, the module (B1) is based on an analysis of the visual input with respect to the main body model that allows the localization of the main body and the evaluation of a set of main body model parameter values.

In one implementation, the module (A1) creates new arm hypotheses that are based on detected arm extremities candidates. This is achieved by (a) extracting contours from the depth map received in the RGBD frame; (b) carving these inside a mask that represent all reliable depth values; (c) skeleton extraction; (d) evaluation of shape descriptors towards extremities detection; and (e) exploitation of extremities towards the formulation of hypotheses about the 3D configuration of the arms. Each arm hypothesis is evaluated by an objective function that scores its plausibility. In one implementation, the criteria taken into account in the objective function include the compatibility of a hypothesis to the observed input and/or the compatibility of the hypothesis to the estimated main human body model, temporal continuity, etc. For example, if the score of an arm hypothesis is below a certain threshold, the hypothesis is rejected.

In one implementation, modules (B2) and (A2) propagate, through tracking, the available previous estimations of B(t−1) and A(t−1), respectively, to the current frame to form hypotheses of the corresponding new parts in the current frame.

In one implementation, the module (B3) evaluates and combines the hypotheses produced by the respective detection (B1) and propagation (B2) modules, forming the (possibly null) estimation of the human body at frame t (B(t)). Similarly, the module (A3) evaluates, refines and combines the hypotheses produced by the respective detection (A1) and propagation (A2) modules, forming the (possibly null) estimation of the human arms at frame t (A(t)). In one implementation, (A3) also accepts as input the main body model estimation B(t) resulting from module (B3) so as to exploit the constraints on the arms that come as a result of this estimation (e.g., position of shoulders).

In the embodiments above, the ARS first identifies users based on head and shoulder joints, and subsequently identifies the locations of the hands (wrists) and elbows. In further embodiments, the ARS may first identify users based on any subset of body joints, and subsequently identify the locations of other body joints.

Further, the order of the identification of body parts by the ARS may be different than described above. Any body part, such as for example the torso, the hips, a hand, or a leg, may be resolved first and bound to estimations of users' body, arms and/or legs from previous frames, and subsequently, the rest of the skeleton may be resolved using the techniques described above for the arms, but applied to other body parts.

Further, the order of the identification of body parts by the ARS may be dynamic. In other words, the first group of body parts to be resolved might depend on dynamic conditions. For example, if a user is standing sideways and their left arm is the most clearly visible part of their body, the skeleton resolution system may identify the user using that arm (rather than the head triangle), and subsequently resolve other parts of the skeleton and/or the skeleton as a whole.

In embodiments, the ARS further includes methods for accurately determining both the position of the tip of the body part, e.g., a hand, as well as the angle of the hand.

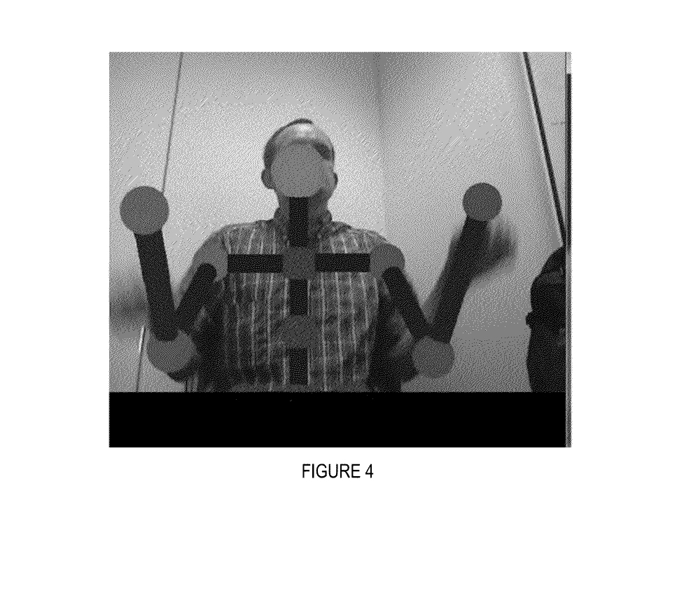

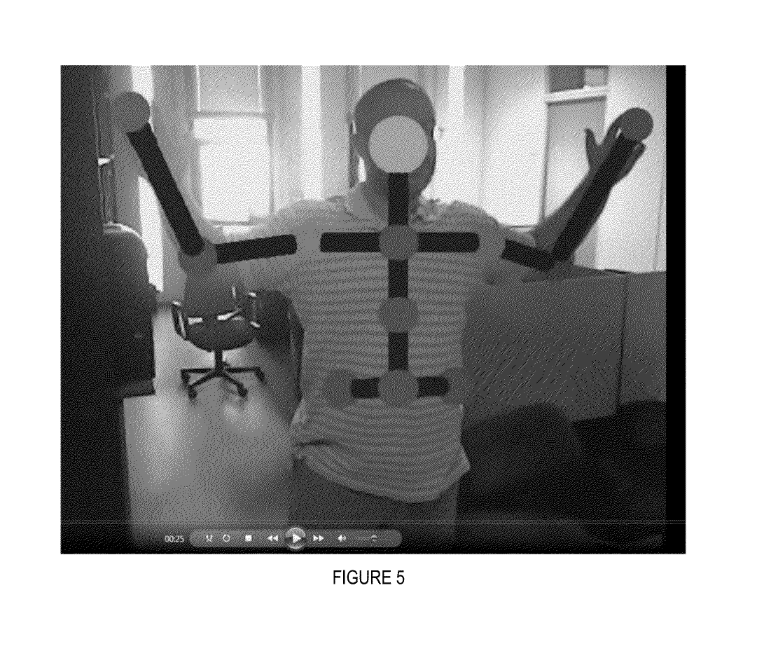

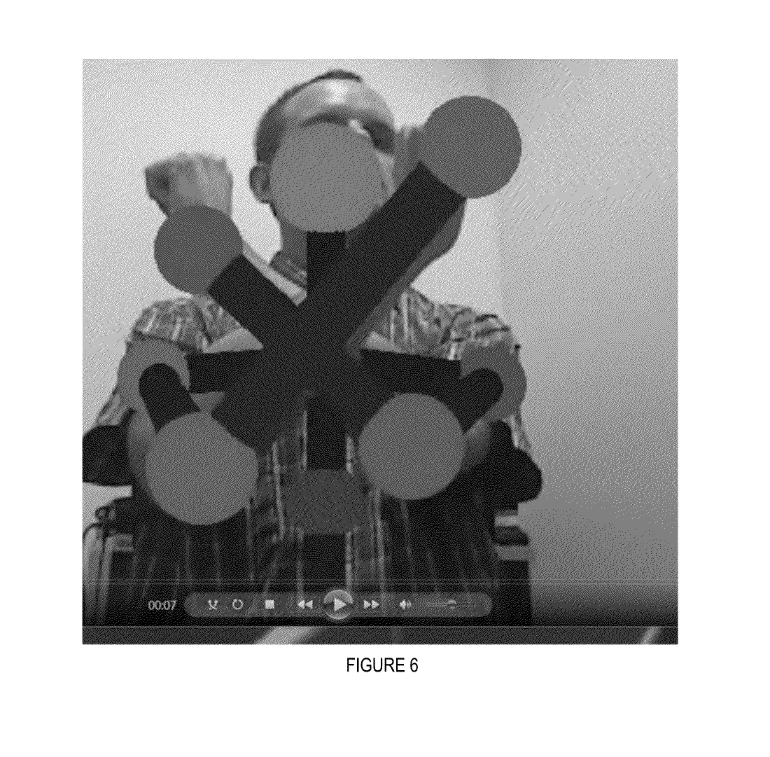

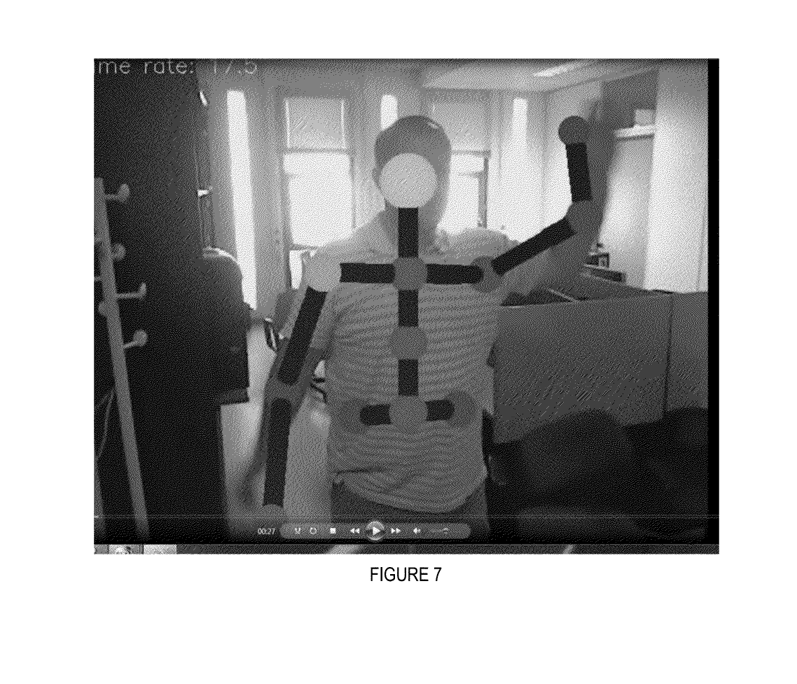

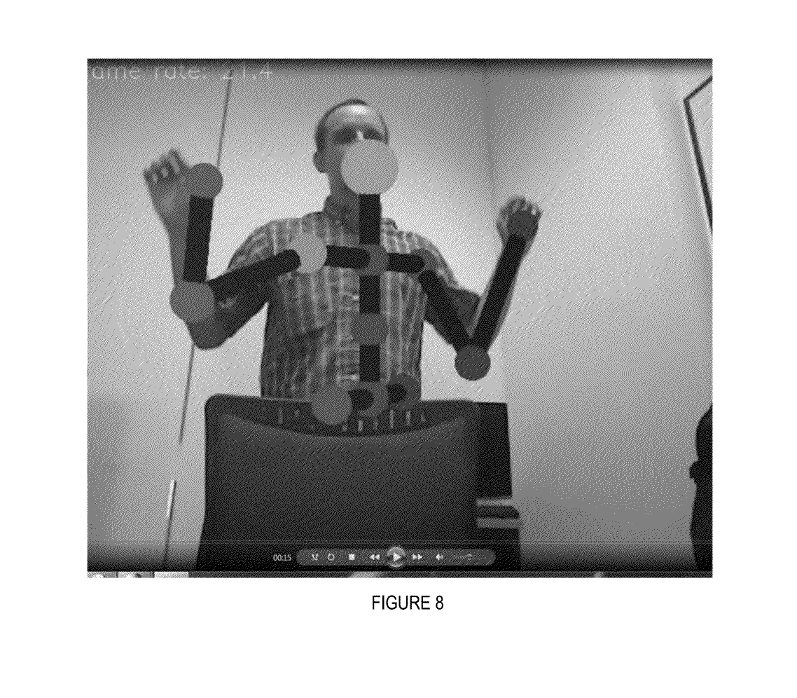

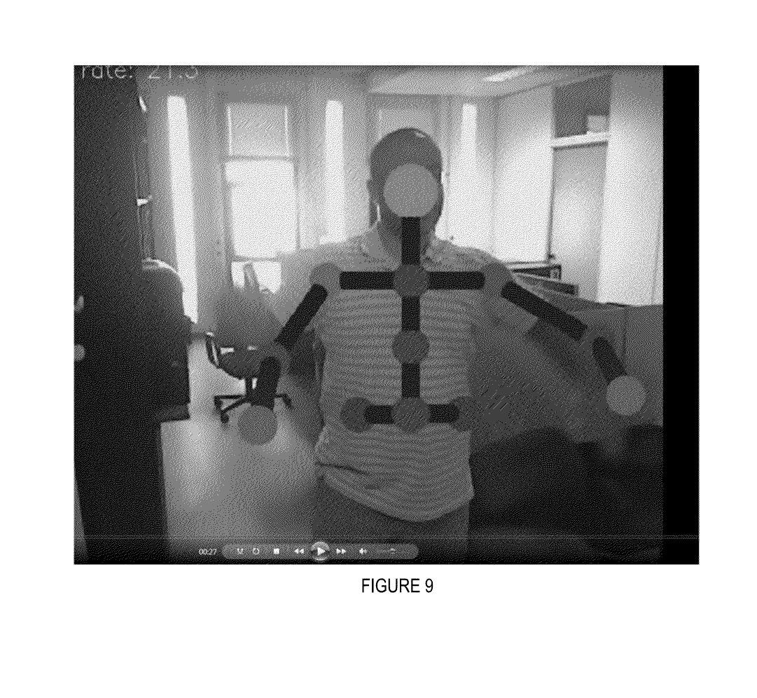

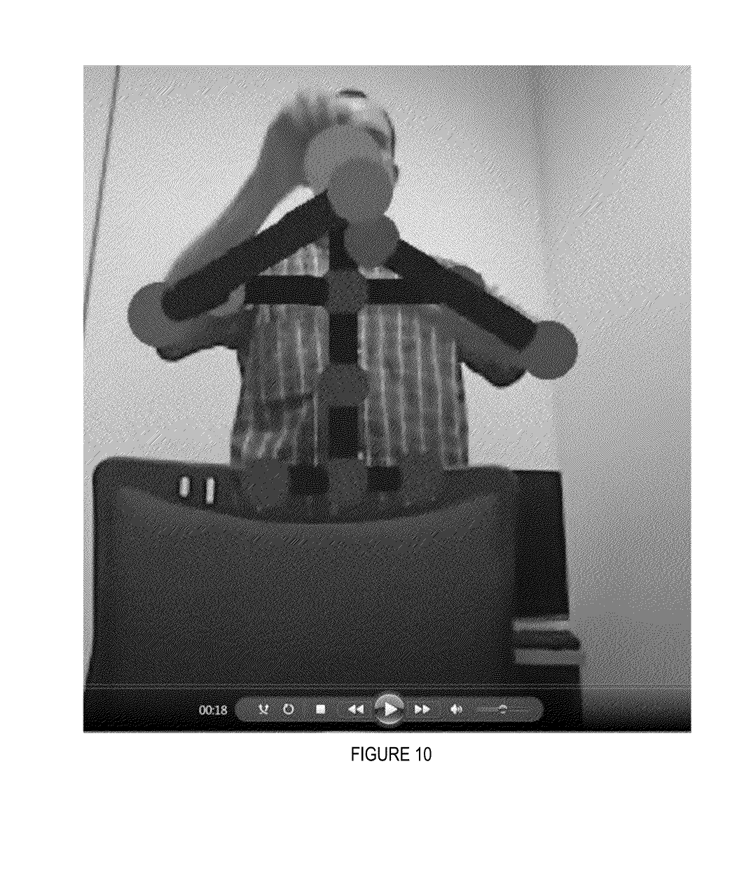

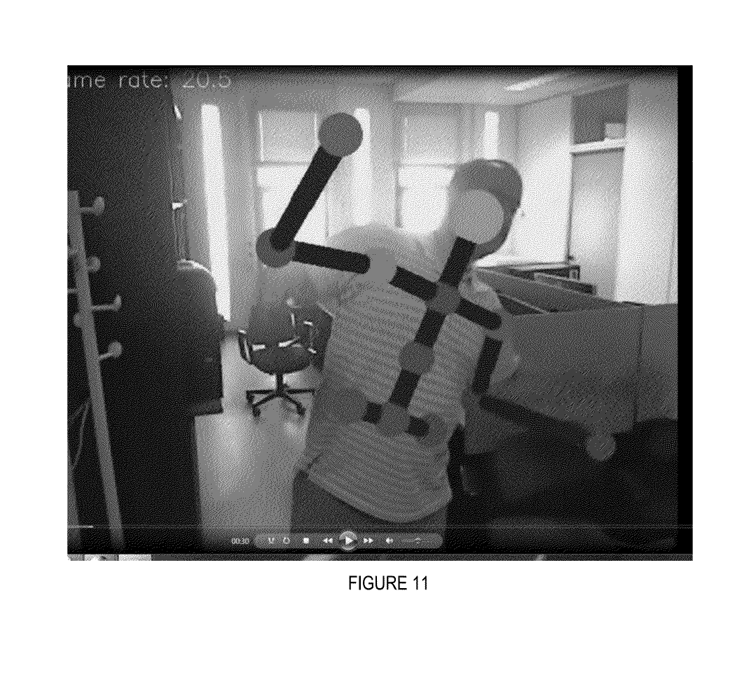

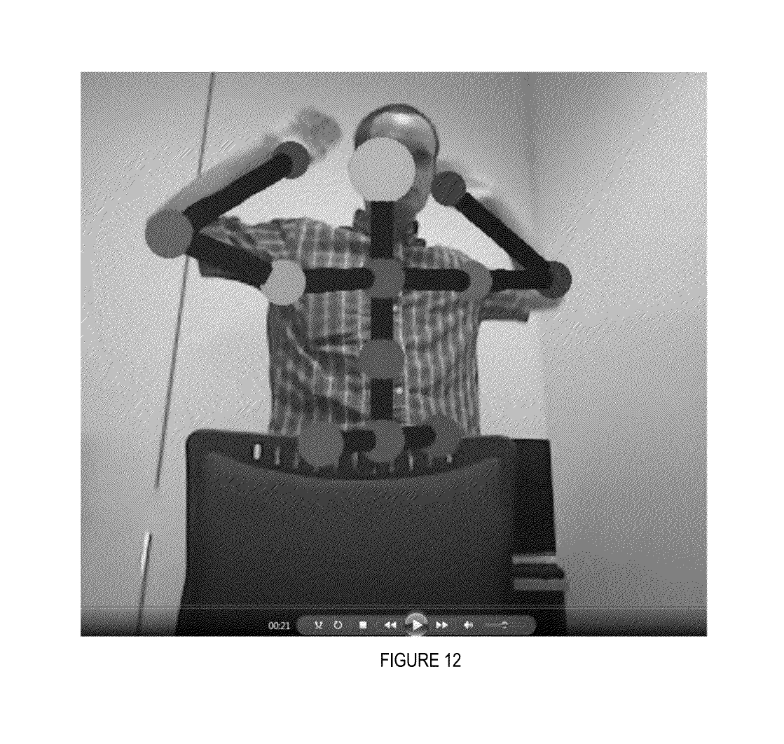

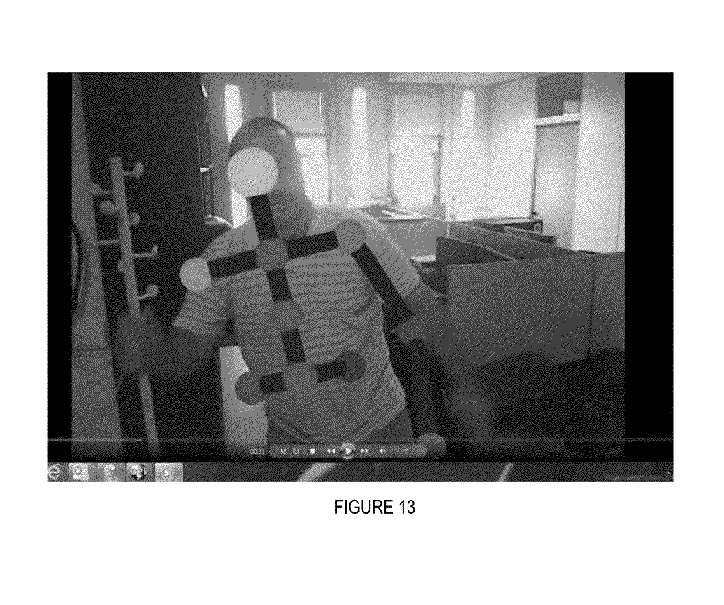

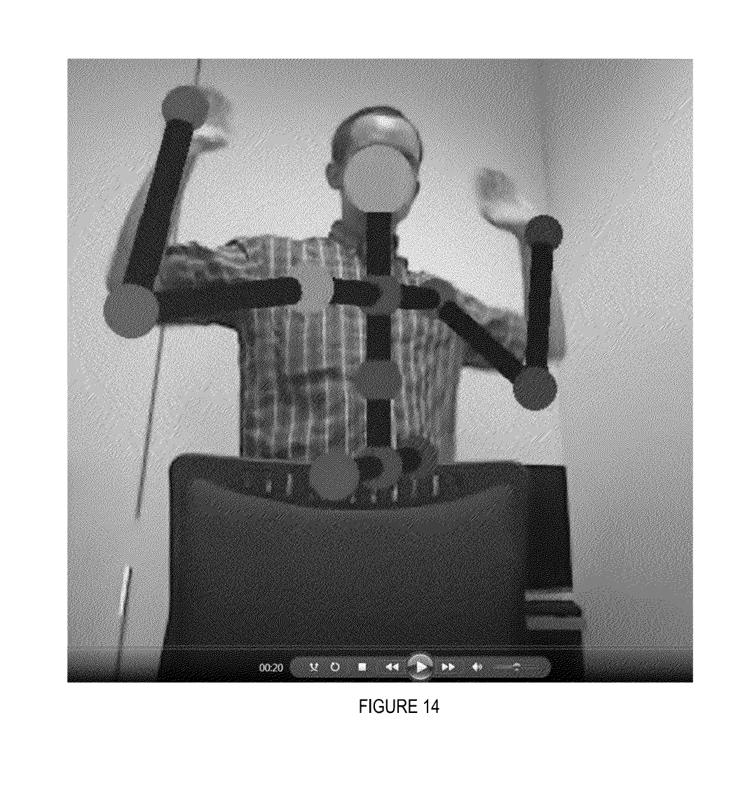

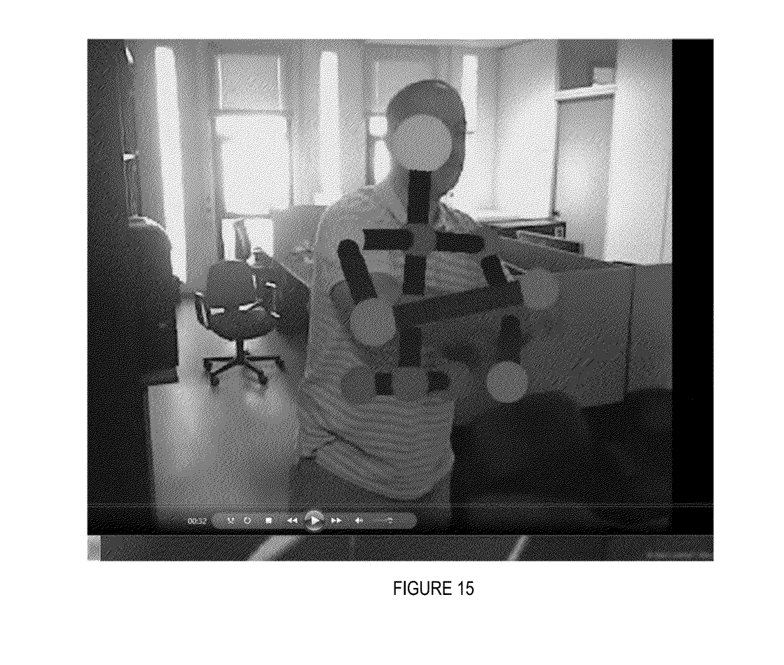

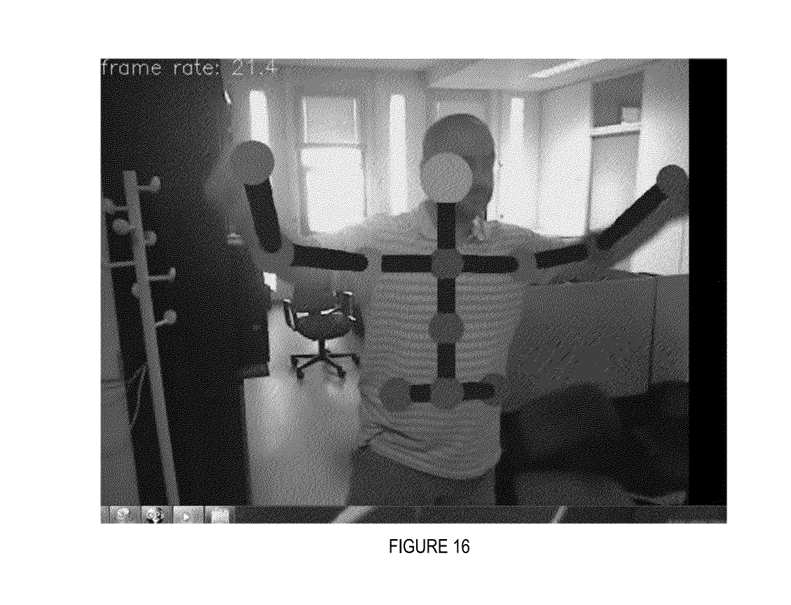

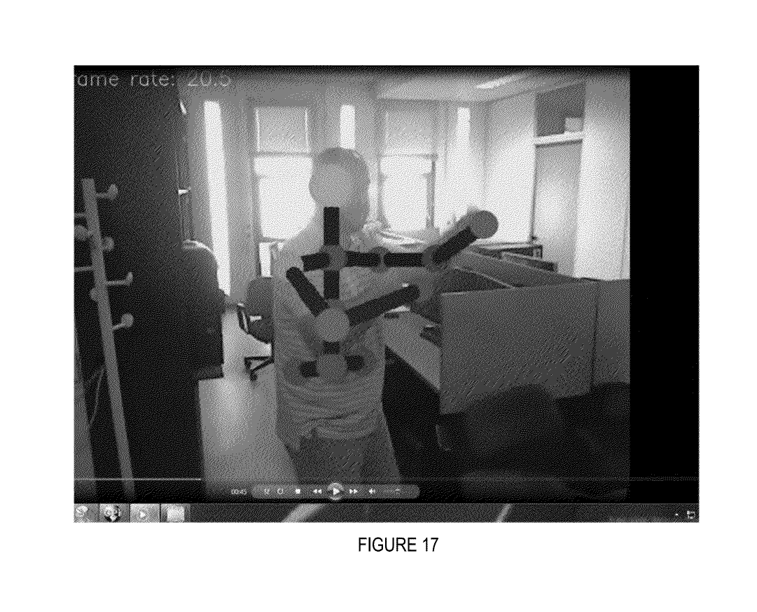

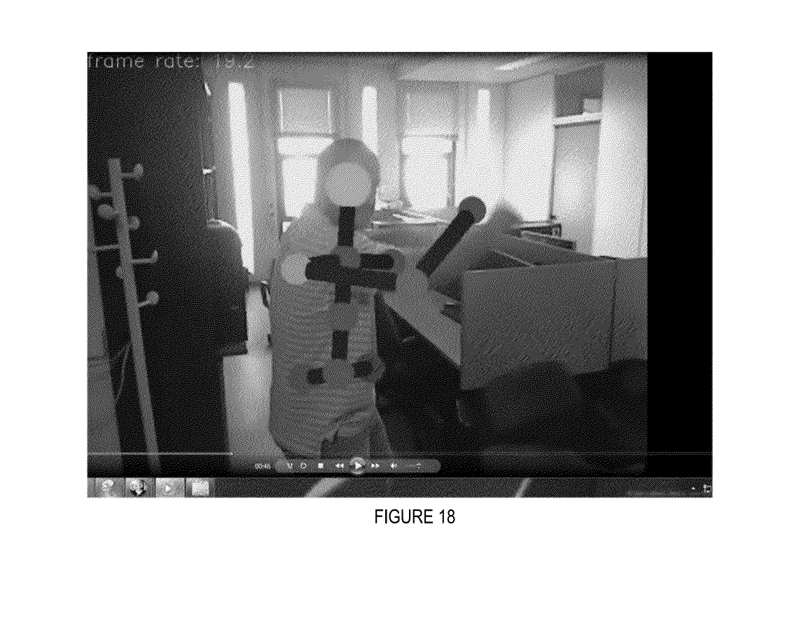

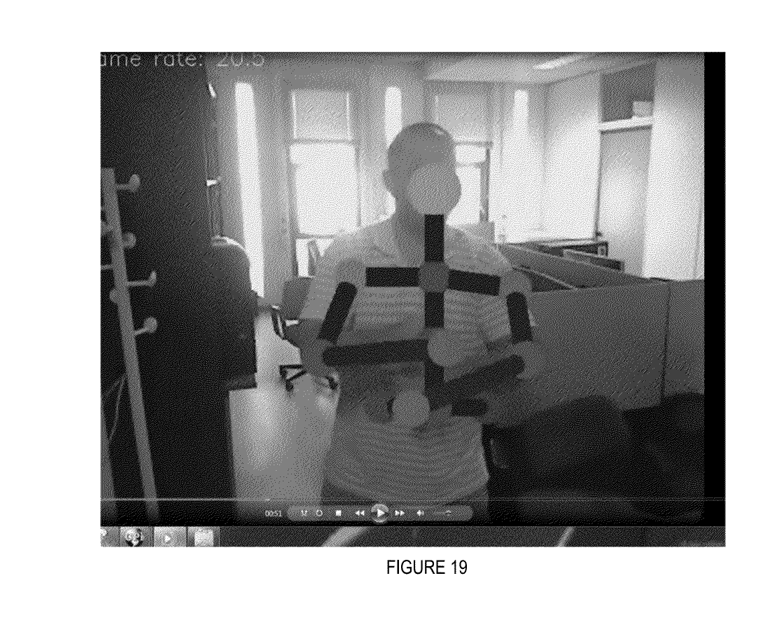

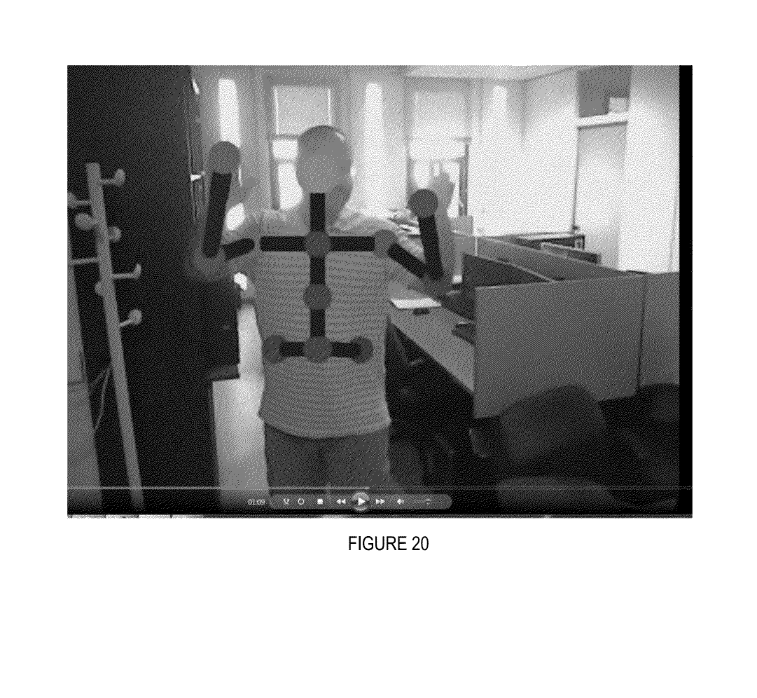

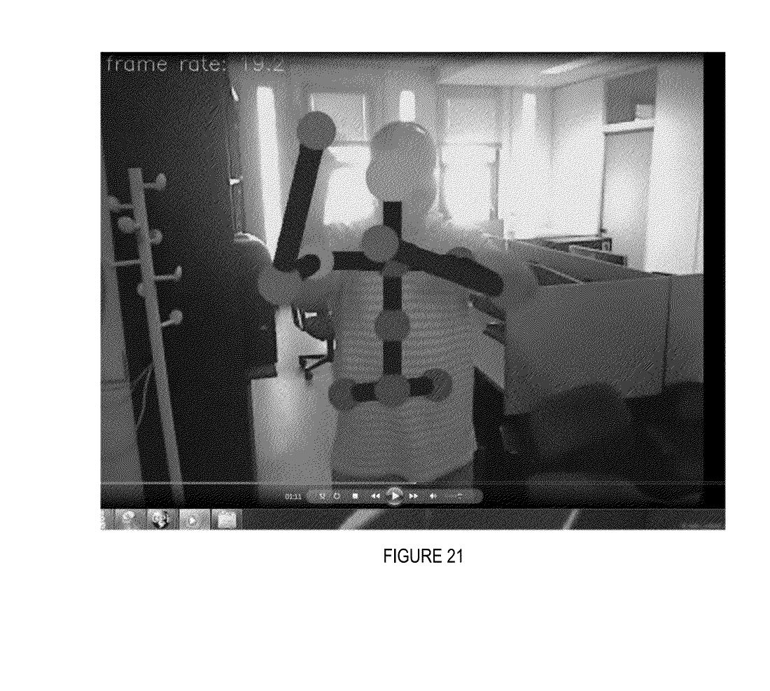

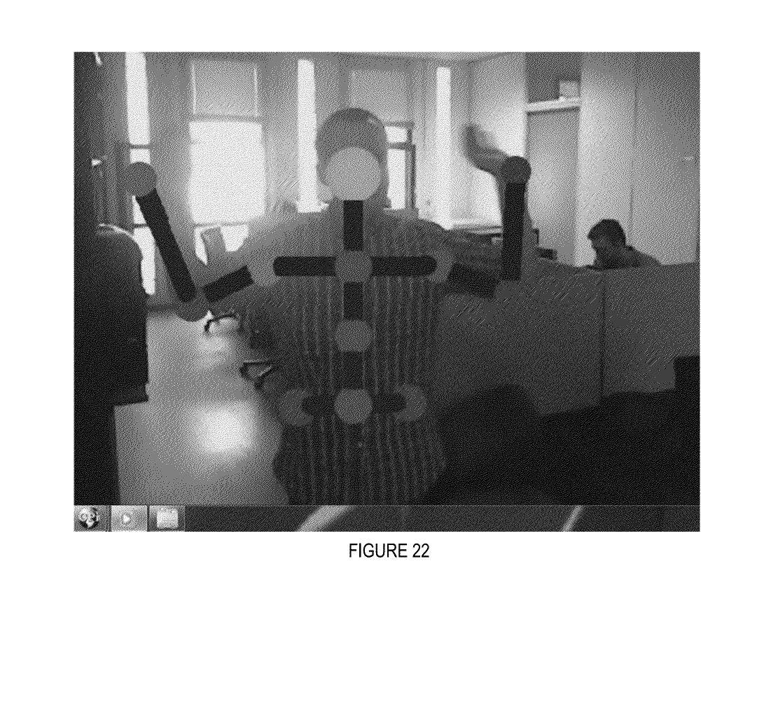

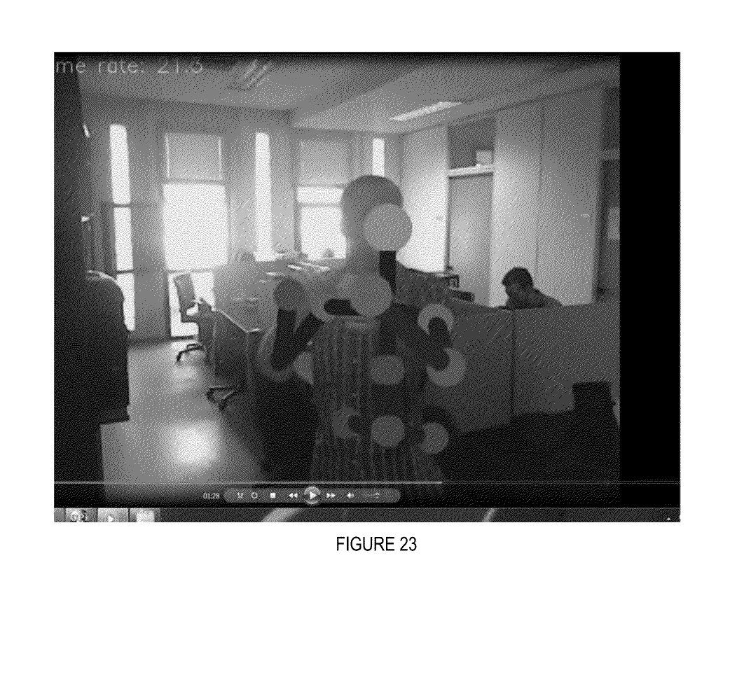

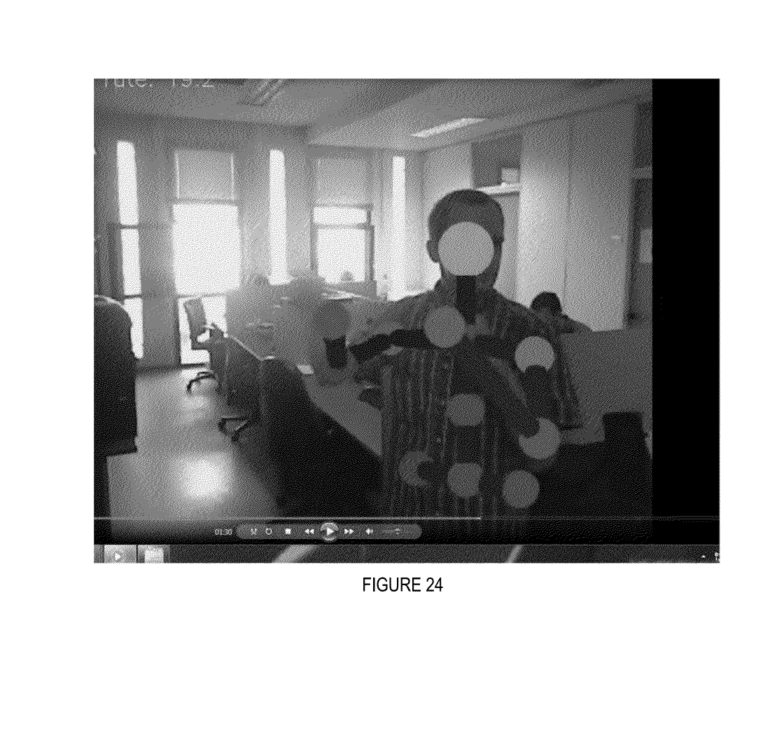

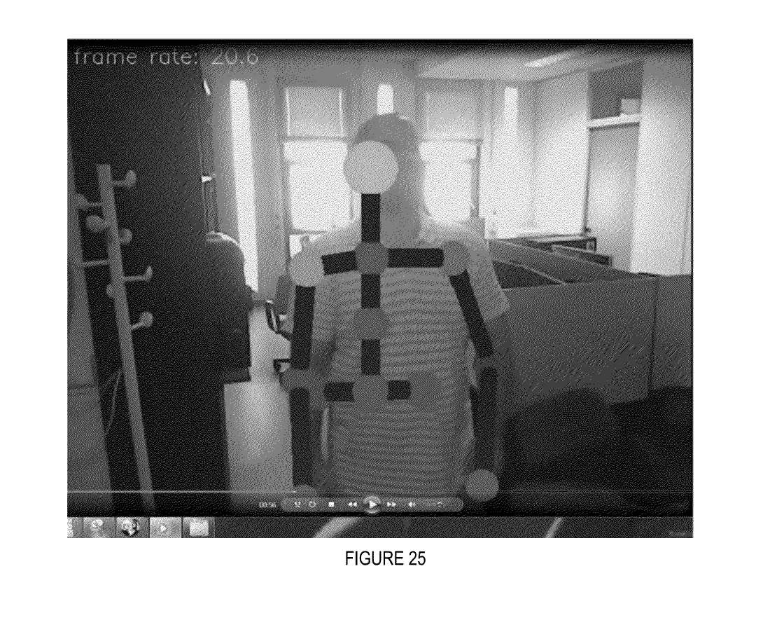

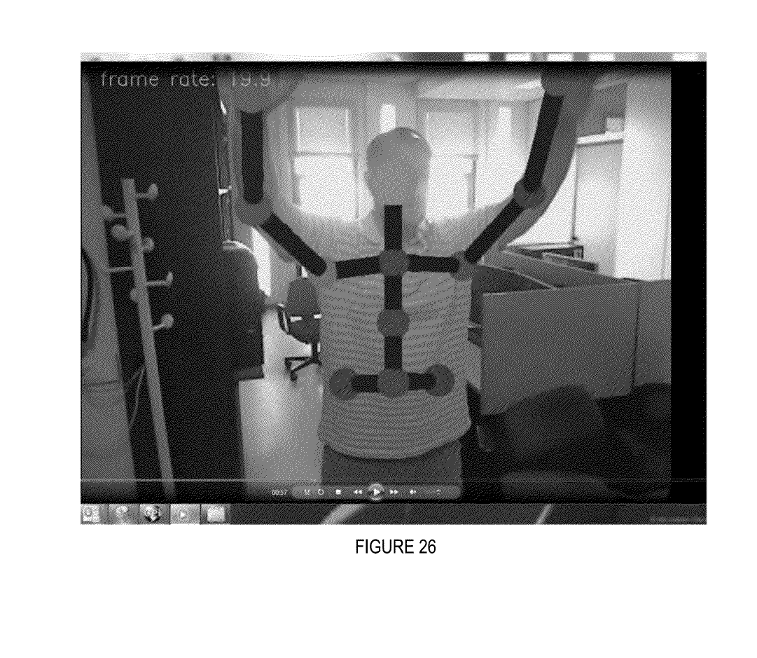

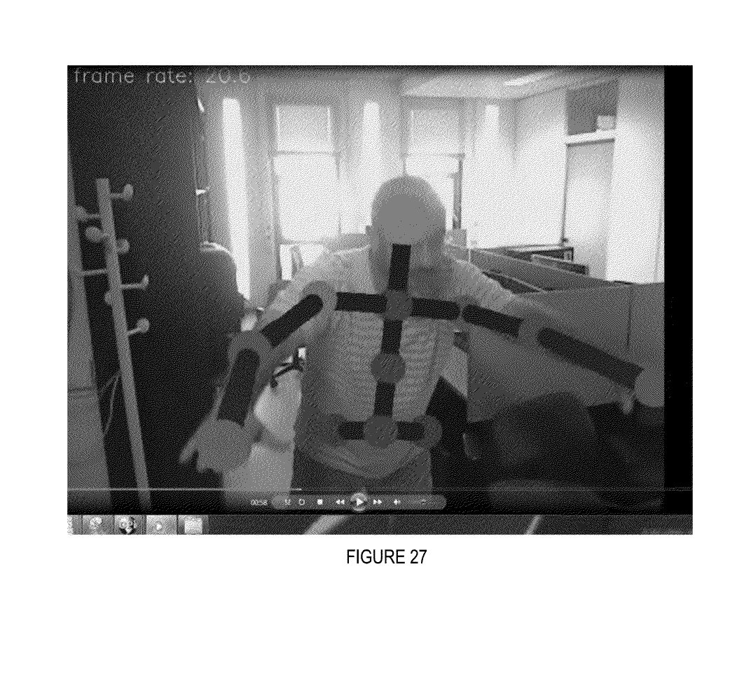

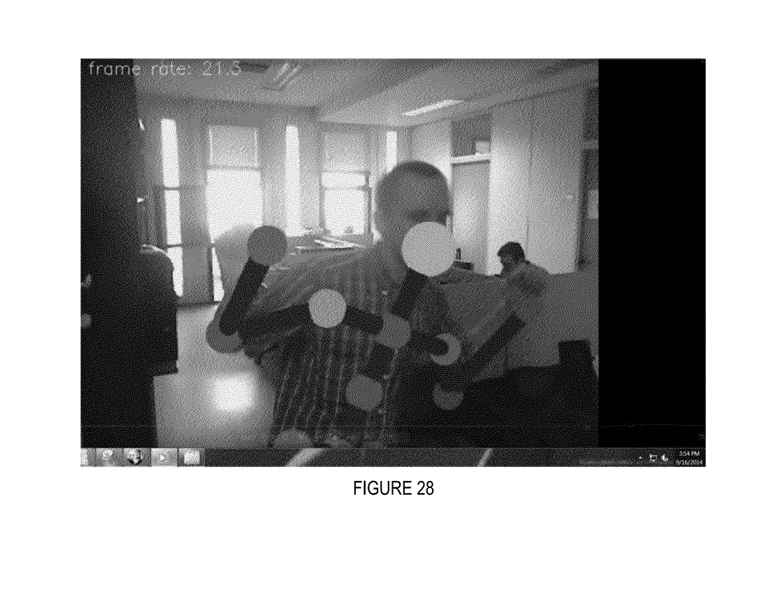

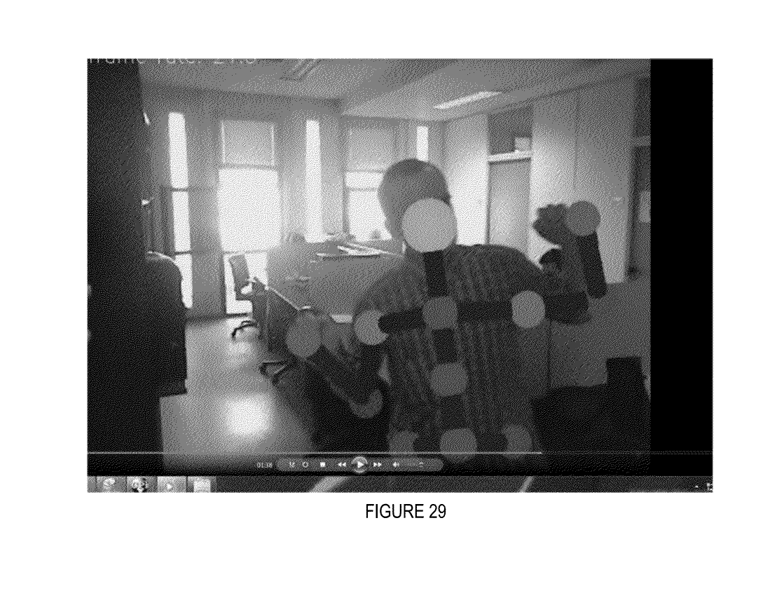

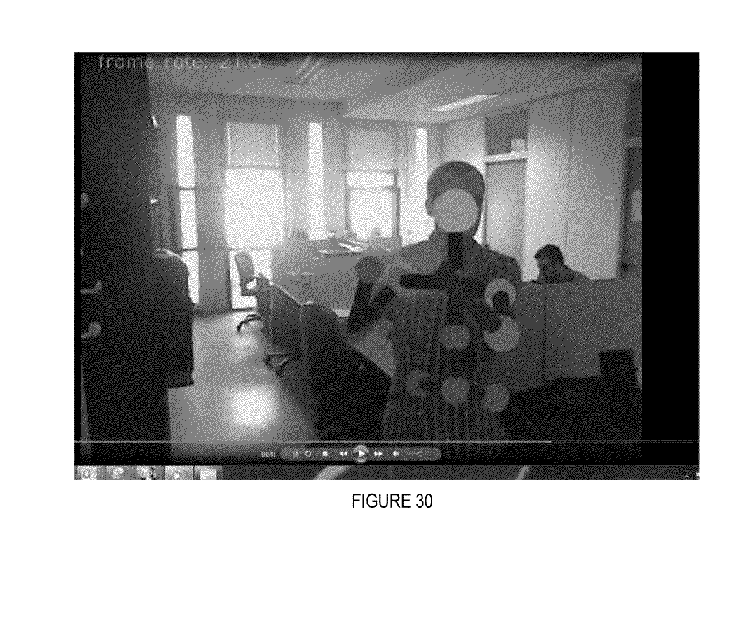

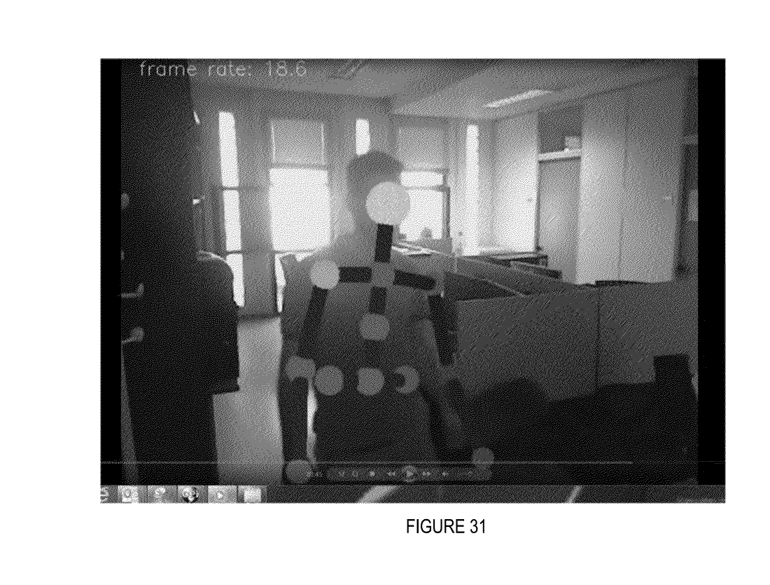

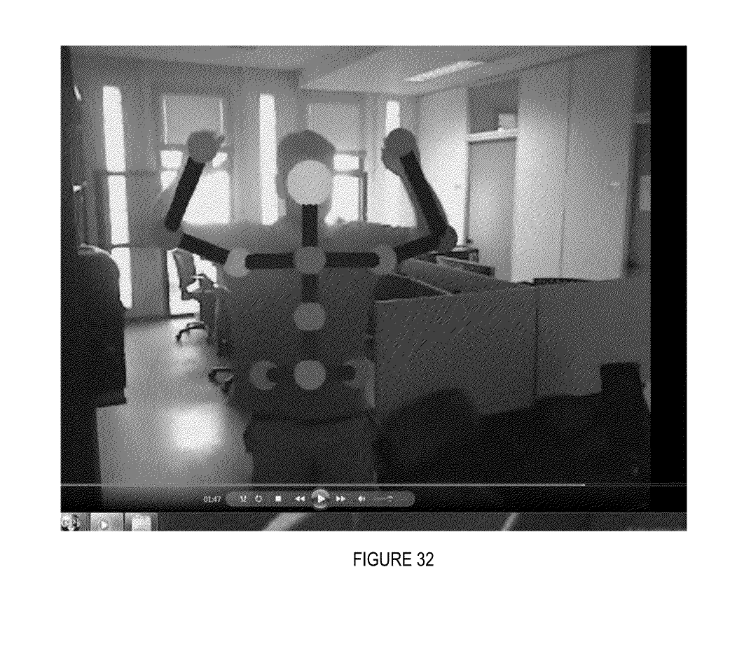

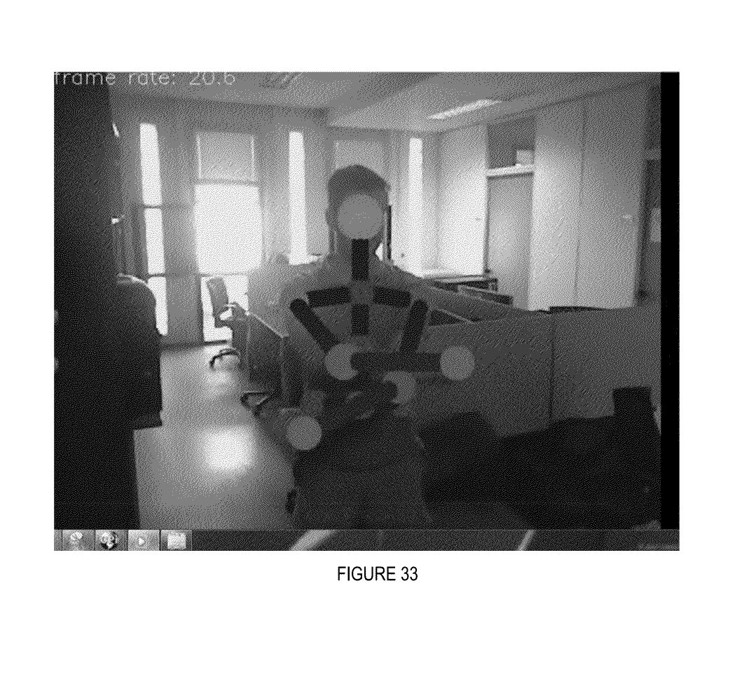

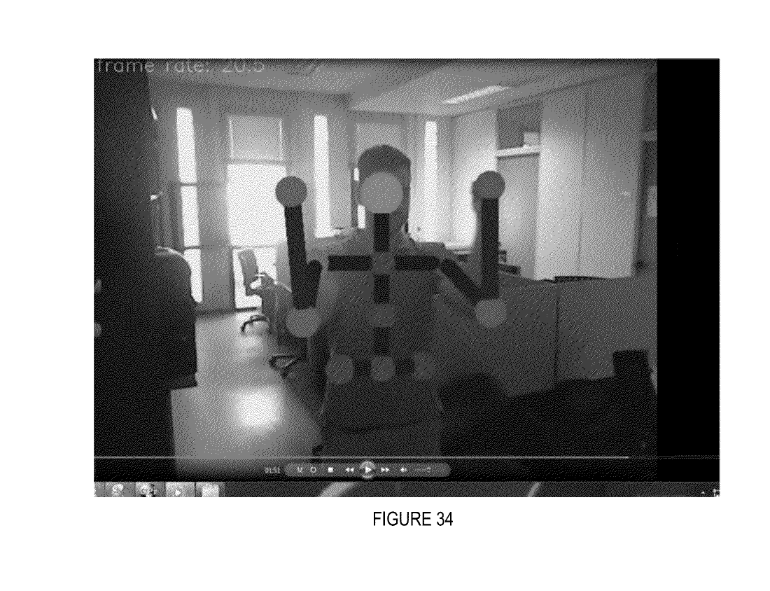

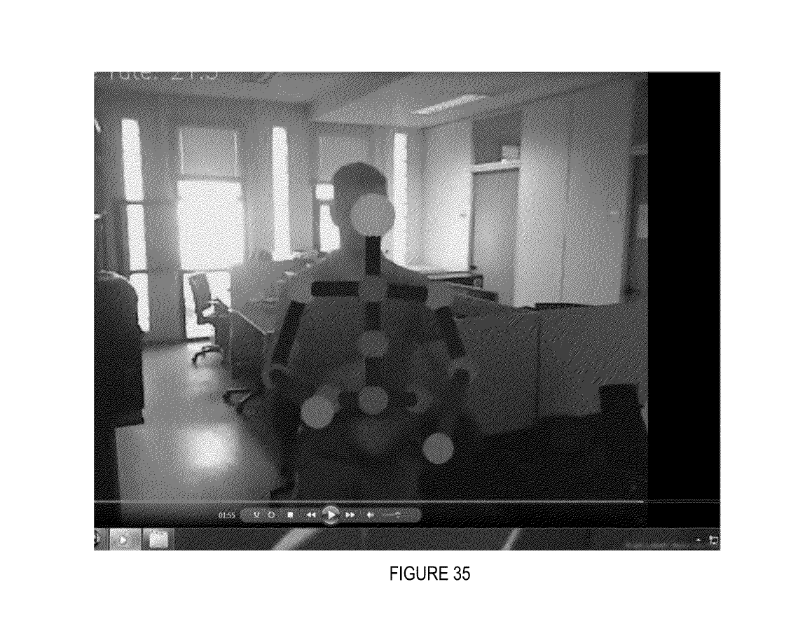

FIGS. 4-36 depict a series of screenshots of an exemplary computer-implemented ARS, according to an implementation of the present subject matter.

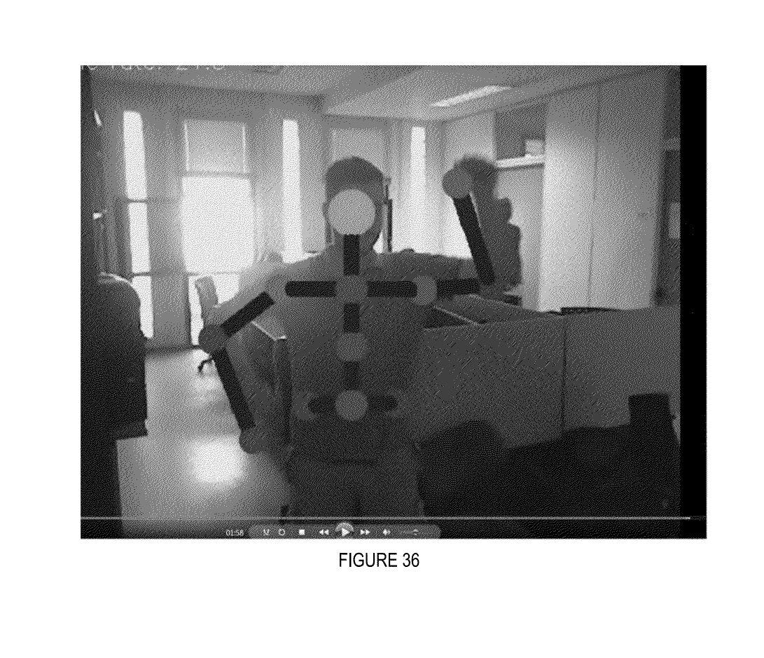

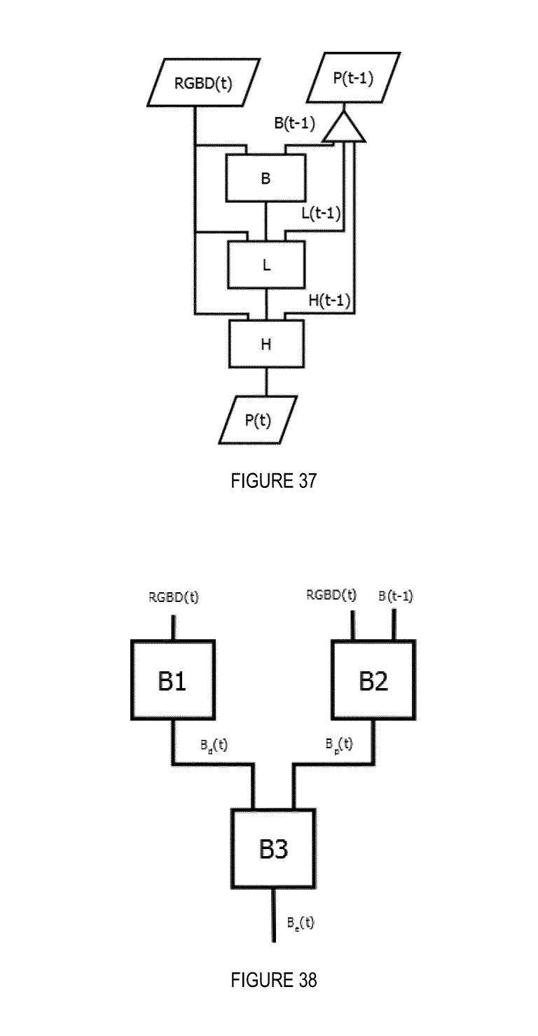

FIG. 37 is a flow diagram of another embodiment of an ARS system. In this example, the ARS system may be divided into three main modules, each performing sequentially detection and tracking of the main body (torso and head, module B), the limbs (arms and legs, module L), and the hands (module H). They take as an input the RGBD frame, the previous pose of the body if available, and the output P(t−1) of the estimation at the previous time instance, t−1.

FIG. 38 is a flow diagram of a body detection and tracking module (module B) of an exemplary ARS system shown in FIG. 37. B1 performs detection of the body at time t, B2 propagates the previous guess B(t−1) to the current frame and B3 fuses the two guesses.

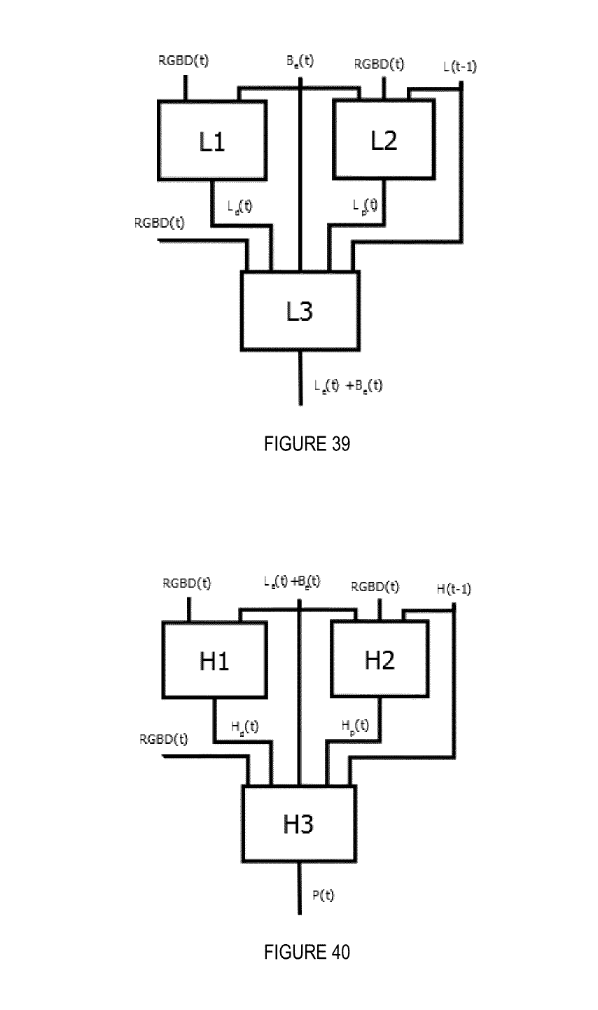

FIG. 39 is a flow diagram of a limbs detection and tracking module (module L) of the exemplary ARS system shown in FIG. 37. L1 gives a set of single shot detection guesses for each limb, L2 propagates the limbs of the previous frame, and L3 select the best compatible combination of guesses for each limb. L1 and L2 can further be divided each into two modules, for the legs and the arms.

FIG. 40 is a flow diagram of a hands detection and tracking module (module H) of the exemplary ARS system shown in FIG. 37. H1 and H2 give respectively detection and propagation guesses, for each arm given by the module L. H3 selects the most likely hand hypotheses and then combines and refines all the results to create the final guess for the body pose.

The order in which both the various methods described herein and in the appendices is not intended to be construed as a limitation, and any number of the described method steps can be combined in any order to implement the methods, or an alternative method. Additionally, individual steps may be deleted from or added to the methods described herein without departing from the spirit and scope of the subject matter described herein. Furthermore, the methods can be implemented in any suitable hardware, software, firmware, or combination thereof. The methods may also be taught to a user through written, pictographic, audio or audiovisual instructions.

It will be recognized that applications of the ARS are not limited to upper body related configurations, but can also be used to track, encode, and transmit information regarding movement of other parts of the body, such as a lower part of the body. As an example, applications of the ARS go beyond the use of gaming, but can also be used for other applications involving human-computer interaction and human-robot interaction.

### ARS Controller

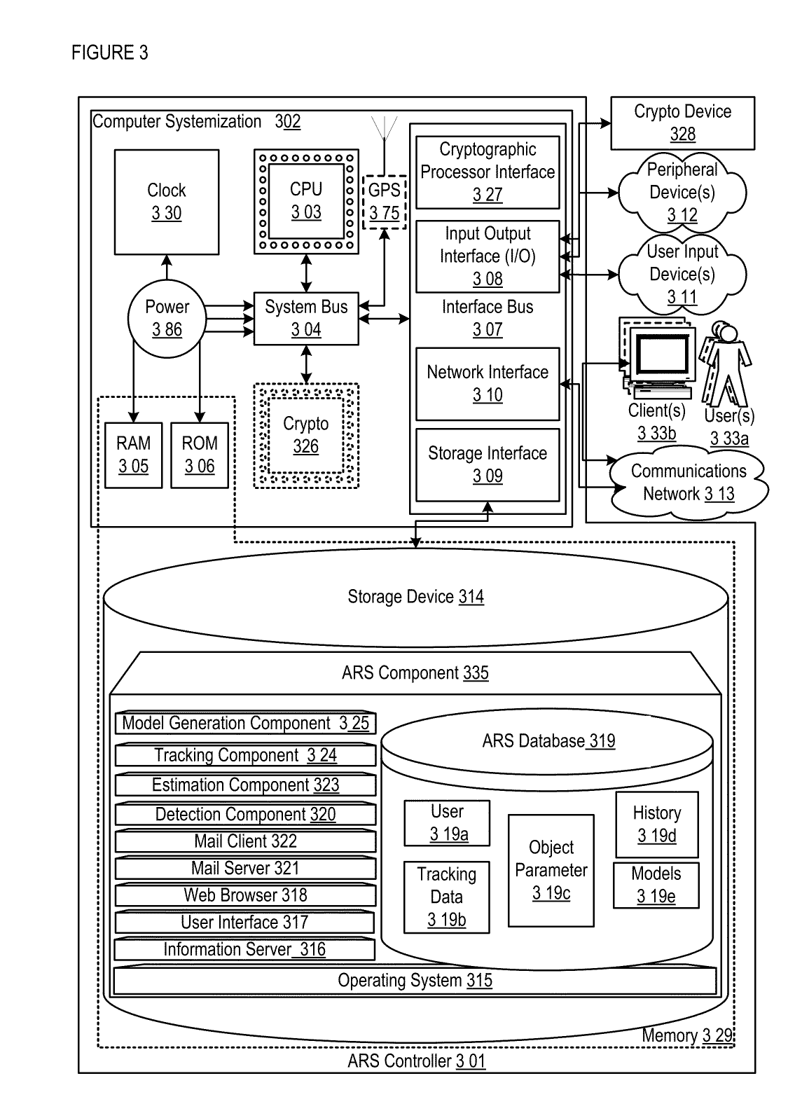

FIG. 3 is an exemplary illustration of inventive aspects of a ARS controller 301 in a block diagram. In this embodiment, the ARS controller 301 may serve to aggregate, process, store, search, serve, identify, instruct, generate, match, and/or facilitate interactions with a computer through user-selected information resource collection generation and management technologies, and/or other related data.

Typically, users, which may be people and/or other systems, may engage information technology systems (e.g., computers) to facilitate information processing. In turn, computers employ processors to process information; such processors 303 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 329 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the ARS controller 301 may be connected to and/or communicate with entities such as, but not limited to: one or more users from user input devices 311; peripheral devices 312; an optional cryptographic processor device 328; and/or a communications network 313.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The ARS controller 301 may be based on computer systems that may comprise, but are not limited to, components such as: a computer systemization 202 connected to memory 329.

### Computer Systemization

A computer systemization 302 may comprise a clock 330, central processing unit (“CPU(s)” and/or “processor(s)” (these terms are used interchangeable throughout the disclosure unless noted to the contrary)) 303, a memory 329 (e.g., a read only memory (ROM) 306, a random access memory (RAM) 305, etc.), and/or an interface bus 307, and most frequently, although not necessarily, are all interconnected and/or communicating through a system bus 304 on one or more (mother)board(s) 302 having conductive and/or otherwise transportive circuit pathways through which instructions (e.g., binary encoded signals) may travel to effect communications, operations, storage, etc. Optionally, the computer systemization may be connected to an internal power source 386. Optionally, a cryptographic processor 326 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 329 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the ARS controller 301 and beyond through various interfaces. Should processing requirements dictate a greater amount speed and/or capacity, distributed processors (e.g., Distributed ARS), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the ARS may be achieved by implementing a microcontroller such as CAST's R8051XC2 microcontroller; Intel's MCS 51 (i.e., 8051 microcontroller); and/or the like. Also, to implement certain features of the ARS, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the ARS component collection (distributed or otherwise) and/or features may be implemented via the microprocessor and/or via embedded components; e.g., via ASIC, coprocessor, DSP, FPGA, and/or the like. Alternately, some implementations of the ARS may be implemented with embedded components that are configured and used to achieve a variety of features or signal processing.

Depending on the particular implementation, the embedded components may include software solutions, hardware solutions, and/or some combination of both hardware/software solutions. For example, ARS features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the ARS features. A hierarchy of programmable interconnects allow logic blocks to be interconnected as needed by the ARS system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the ARS may be developed on regular FPGAs and then migrated into a fixed version that more resembles ASIC implementations. Alternate or coordinating implementations may migrate ARS controller features to a final ASIC instead of or in addition to FPGAs. Depending on the implementation all of the aforementioned embedded components and microprocessors may be considered the “CPU” and/or “processor” for the ARS.

### Power Source

The power source 386 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 386 is connected to at least one of the interconnected subsequent components of the ARS thereby providing an electric current to all subsequent components. In one example, the power source 286 is connected to the system bus component 304. In an alternative embodiment, an outside power source 386 is provided through a connection across the I/O 308 interface. For example, a USB and/or IEEE 1394 connection carries both data and power across the connection and is therefore a suitable source of power.

### Interface Adapters

Interface bus(ses) 307 may accept, connect, and/or communicate to a number of interface adapters, conventionally although not necessarily in the form of adapter cards, such as but not limited to: input output interfaces (I/O) 308, storage interfaces 309, network interfaces 310, and/or the like. Optionally, cryptographic processor interfaces 327 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 309 may accept, communicate, and/or connect to a number of storage devices such as, but not limited to: storage devices 214, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 310 may accept, communicate, and/or connect to a communications network 313. Through a communications network 313, the ARS controller is accessible through remote clients 333b (e.g., computers with web browsers) by users 333a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed ARS), architectures may similarly be employed to pool, load balance, and/or otherwise increase the communicative bandwidth required by the ARS controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 310 may be used to engage with various communications network types 313. For example, multiple network interfaces may be employed to allow for the communication over broadcast, multicast, and/or unicast networks.

Input Output interfaces (I/O) 308 may accept, communicate, and/or connect to user input devices 311, peripheral devices 212, cryptographic processor devices 328, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 311 may be card readers, dongles, finger print readers, gloves, graphics tablets, joysticks, keyboards, mouse (mice), remote controls, retina readers, trackballs, trackpads, and/or the like.

Peripheral devices 312 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the ARS controller may be embodied as an embedded, dedicated, and/or monitor-less (i.e., headless) device, wherein access would be provided over a network interface connection.

Cryptographic units such as, but not limited to, microcontrollers, processors 326, interfaces 327, and/or devices 328 may be attached, and/or communicate with the ARS controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 329. However, memory is a fungible technology and resource, thus, any number of memory embodiments may be employed in lieu of or in concert with one another. It is to be understood that the ARS controller and/or a computer systemization may employ various forms of memory 329. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 329 will include ROM 306, RAM 305, and a storage device 314. A storage device 314 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 329 may contain a collection of program and/or database components and/or data such as, but not limited to: operating system component(s) 315 (operating system); information server component(s) 316 (information server); user interface component(s) 317 (user interface); Web browser component(s) 318 (Web browser); database(s) 319; mail server component(s) 321; mail client component(s) 322; detection component 320; estimation component 323; tracking component 324; model generation component 325; the ARS component(s) 335; the other components such as mapping components (not shown), and/or the like (i.e., collectively a component collection). These components may be stored and accessed from the storage devices and/or from storage devices accessible through an interface bus. Although non-conventional program components such as those in the component collection, typically, are stored in a local storage device 314, they may also be loaded and/or stored in memory such as: peripheral devices, RAM, remote storage facilities through a communications network, ROM, various forms of memory, and/or the like.

### Operating System

The operating system component 315 is an executable program component facilitating the operation of the ARS controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the ARS controller to communicate with other entities through a communications network 313. Various communication protocols may be used by the ARS controller as a subcarrier transport mechanism for interaction, such as, but not limited to: multicast, TCP/IP, UDP, unicast, and/or the like.

### Information Server

An information server component 316 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the ARS controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the ARS database 319, operating systems, other program components, user interfaces, Web browsers, and/or the like.

Access to the ARS database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the ARS. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the ARS as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM′sOS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 317 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 318 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the ARS enabled nodes. The combined application may be nugatory on systems employing standard Web browsers.

### Mail Server

A mail server component 321 is a stored program component that is executed by a CPU 303. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the ARS.

Access to the ARS mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 322 is a stored program component that is executed by a CPU 303. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 320 is a stored program component that is executed by a CPU 303, cryptographic processor 326, cryptographic processor interface 327, cryptographic processor device 328, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the ARS may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the ARS component to engage in secure transactions if so desired. The cryptographic component facilitates the secure accessing of resources on the ARS and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The ARS Database

The ARS database component 319 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the ARS database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the ARS database is implemented as a data-structure, the use of the ARS database 319 may be integrated into another component such as the ARS component 335. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 319 includes several tables 319a-e. A user accounts table 319a may include fields such as, but not limited to: user_id, name, contact_info, account_identifier, login, password, private_key, public_key, user_interface_interactions, content_ID, ad_ID, device_ID, and/or the like. The user table may support and/or track users interfacing or interacting with the ARS controller 301. A tracking data table 319b may include fields such as, but not limited to: pastframe_data, currentframe_data, mappeddata, depth_Frame_Data, skeleton_point_Data, and/or the like. An object parameter table 319c may include fields such as, but not limited to: object_type, object_name, and/or the like. A history table 319d may include historical data from past interactions stored in fields such as, but not limited to: history_timestamp, history_parameters, and/or the like. This data may be accessed to better the knowledge base and/or explore areas of improvement. A models table 319e may include fields such as, but not limited to: model_type, model_hand, model_finger, model_palm, model_Variables, model_parameters, model_upperbody, model_lower body, and/or the like.

In one embodiment, the ARS database may interact with other database systems. For example, employing a distributed database system, queries and data access by search ARS component may treat the combination of the ARS database, an integrated data security layer database as a single database entity.

In one embodiment, user programs may contain various user interface primitives, which may serve to update the ARS. Also, various accounts may require custom database tables depending upon the environments and the types of users the ARS may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 319a-e. The ARS may be configured to keep track of various settings, inputs, and parameters via database controllers.

The ARS database may communicate to and/or with other components in a component collection, including itself, and/or facilities of the like. Most frequently, the ARS database communicates with the ARS component, other program components, and/or the like. The database may contain, retain, and provide information regarding other nodes and data.

### The ARSs

The ARS component 335 is a stored program component that is executed by a CPU. In one embodiment, the ARS component incorporates any and/or all combinations of the aspects of the ARS that was discussed in the previous figures. As such, the ARS affects accessing, obtaining and the provision of information, services, transactions, and/or the like across various communications networks.

The ARS component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the ARS server employs a cryptographic server to encrypt and decrypt communications. The ARS component may communicate to and/or with other components in a component collection, including itself, and/or facilities of the like. Most frequently, the ARS component communicates with the ARS database, operating systems, other program components, and/or the like. The ARS may contain, communicate, generate, obtain, and/or provide program component, system, user, and/or data communications, requests, and/or responses.

### Distributed ARSs

The structure and/or operation of any of the ARS node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the ARS controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c -post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

In order to address various issues and improve over previous works, the application is directed to APPARATUSES, METHODS AND SYSTEMS FOR RECOVERING A 3-DIMENSIONAL SKELETAL MODEL OF THE HUMAN BODY. The entirety of this application (including the Cover Page, Title, Headings, Field, Related Art, Summary, Brief Description of the Drawings, Detailed Description, Claims, Abstract, Figures, and otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs and/or characteristics of a ARS individual and/or enterprise user, database configuration and/or relational model, data type, data transmission and/or network framework, syntax structure, and/or the like, various embodiments of the ARS, may be implemented that enable a great deal of flexibility and customization. Furthermore, aspects of the ARS may be adapted for hand or leg gestures, and human-machine interaction in any field such as manufacturing, robotics, gaming, etc., and/or the like. While various embodiments and discussions of the ARS have been directed to certain embodiments, however, it is to be understood that the embodiments described herein may be readily configured and/or customized for a wide variety of other applications and/or implementations.

What is claimed is:

1. A processor-implemented method for markerless estimation of a 3D skeletal model of a human body, the method comprising:
(a) receiving a current RGBD frame depicting at least a portion of a human body;
(b) receiving an estimation of the position of the depicted at least one portion of the human body that was estimated based on a previous RGBD frame;
(c) determining at least one hypothesis of a position of the depicted at least one portion of the human body from the current RGBD frame;
(d) comparing the current RGBD frame to the estimation of the position of the depicted at least one portion of the human body that was estimated based on a previous RGBD frame; and
(e) estimating a current position of the depicted at least one portion of the human body based on the at least one hypothesis from (c) and a result of the comparison in (d).

2. The method of claim 1, wherein:
at least two hypotheses of the position of the depicted at least one portion of the human body are determined from the current RGBD frame at (c); and
step (e) includes determining whether to accept one of the at least two hypotheses, refine one of the at least two hypotheses, merge two or more of the at least two hypotheses or reject all hypotheses.

3. The method of claim 1, wherein:
step (d) results in at least one hypothesis of a position of the depicted at least one portion of the human body; and
step (e) includes determining whether to accept one hypothesis from (c) or (d), refine one hypothesis from (c) or (d), merge two or more of the hypotheses from (c) and (d), or reject all hypotheses.

4. A processor-implemented method for markerless estimation of a 3D skeletal model of a human body, the method comprising:
(a) receiving a current RGBD frame depicting at least a body and arms of a human body;
(b) receiving an estimation of the positions of the body and arms of the human body that were estimated based on a previous RGBD frame;
(c) determining at least one body hypothesis of a position of the body of the human body from the current RGBD frame;
(d) determining at least one arms hypothesis of a position of the arms of the human body from the current RGBD frame;
(e) comparing the current RGBD frame to the estimation of the position of the body of the human body that was estimated based on a previous RGBD frame to provide a body comparison;
(f) comparing the current RGBD frame to the estimation of the position of the arms of the human body that was estimated based on a previous RGBD frame to provide an arms comparison;
(g) estimating a current position of the body of the human body based on the at least one body hypothesis from (c) and the body comparison in (e); and
(h) estimating a current position of the arms of the human body based on the at least one arm hypothesis from (d) and the arm comparison in (f).

5. The method of claim 4, wherein estimating a current position of the arms of the human body at (h) is also based on the estimation of the current position of the body of the human body from (g).

6. The method of claim 4, wherein:
at least two body hypotheses of the position of the body of the human body are determined from the current RGBD frame at (c); and
step (g) includes determining whether to accept one of the at least two body hypotheses, refine one of the at least two body hypotheses, merge two or more of the at least two body hypotheses, or reject all body hypotheses.

7. The method of claim 4, wherein:
at least two arm hypotheses of the position of the arm of the human body are determined from the current RGBD frame at (d); and
step (h) includes determining whether to accept one of the at least two arm hypotheses, refine one of the at least two body hypotheses, merge two or more of the at least two arm hypotheses, or reject all arm hypotheses.

8. The method of claim 4, wherein:
step (e) results in at least one hypothesis of a position of the body of the human body; and
step (g) includes determining whether to accept one hypothesis from (c) or (e), refine one hypothesis from (c) or (e), merge two or more of the hypotheses from (c) and (e), or reject all hypotheses.

9. The method of claim 4, wherein:
step (f) results in at least one hypothesis of a position of the body of the human body; and
step (h) includes determining whether to accept one hypothesis from (d) or (f), refine one hypothesis from (d) or (f), merge two or more of the hypotheses from (d) and (f), or reject all hypotheses.

10. A computing device comprising:
a processor;
a display;
a memory communicatively coupled to the processor, wherein the memory comprises:
(a) a RGBD frame receiving module that receives a current RGBD frame depicting at least a portion of a human body;
(b) a historical estimation receiving module that receives an estimation of the position of the depicted at least one portion of the human body that was estimated based on a previous RGBD frame;
(c) a position determination module that determines at least one hypothesis of a position of the depicted at least one portion of the human body from the current RGBD frame;
(d) a comparison module that compares the current RGBD frame to the estimation of the position of the depicted at least one portion of the human body that was estimated based on a previous RGBD frame; and
(e) an estimation module that estimates a current position of the depicted at least one portion of the human body based on the at least one hypothesis from (c) and a result of the comparison by (d).

11. The computing device of claim 10, wherein:
at least two hypotheses of the position of the depicted at least one portion of the human body are determined from the current RGBD frame by the position determination module (c); and
the estimation module (e) determines whether to accept one of the at least two hypotheses, refine one of the at least two hypotheses, merge two or more of the at least two hypotheses, or reject all hypotheses.

12. The computing device of claim 10, wherein:
the comparison module (d) outputs at least one hypothesis of a position of the depicted at least one portion of the human body; and
the estimation module (e) determines whether to accept one hypothesis from the determination module (c) or the comparison module (d), refine one hypothesis from determination module (c) or the comparison module (d), merge two or more of the hypotheses from determination module (c) and the comparison module (d), or reject all hypotheses.
